(19) United States
(12) Patent Application Publication
(10) Pub. No.: US 2025/0224793 A1
(43) Pub. Date: Jul. 10, 2025

(54) ADAPTIVE POWER MODES USING MEMORY USAGE PATTERNS

(71) Applicant: Micron Technology, Inc., Boise, ID (US)

(72) Inventors: Tomer Tzvi Eliash, Sunnyvale, CA (US); Zhenming Zhou, San Jose, CA (US); Yu-Chung Lien, San Jose, CA (US)

(21) Appl. No.: 19/011,034

(22) Filed: Jan. 6, 2025

Related U.S. Application Data
(60) Provisional application No. 63/618,703, filed on Jan. 8, 2024.

(51) Int. Cl. G06F 1/3228

(52) U.S. Cl. CPC G06F 1/3228

(57) ABSTRACT

Methods, systems, and apparatuses include receiving, by a memory subsystem, a power down notification. A memory usage pattern for the memory subsystem is retrieved in response to receiving the power down notification. A power mode is selected using the current time and the memory usage pattern. The selected power mode is enabled.

### CROSS-REFERENCE TO RELATED APPLICATION

The present application claims the benefit of U.S. Provisional Patent Application No. 63/618,703 filed on Jan. 8, 2024, which is incorporated by reference herein in its entirety.

### TECHNICAL FIELD

The present disclosure generally relates to managing power consumption in a memory subsystem, and more specifically, relates to adaptive power modes using memory usage patterns.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 illustrates a graph of example memory usage patterns for a memory subsystem used to select a power mode in accordance with some embodiments of the present disclosure.

FIG. 3 is a flow diagram of an example method to select a power mode using memory usage patterns in accordance with some embodiments of the present disclosure.

FIG. 4 is another flow diagram of an example method to select a power mode using memory usage patterns in accordance with some embodiments of the present disclosure.

FIG. 5 is a block diagram of an example computer system in which embodiments of the present disclosure may operate.

### DETAILED DESCRIPTION

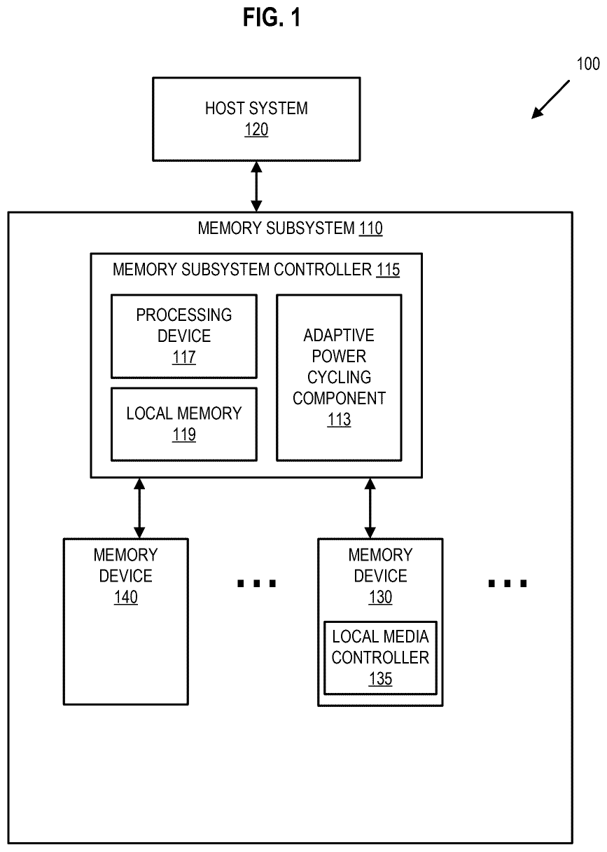

Aspects of the present disclosure are directed to adaptive power modes using memory usage patterns in a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units identified by a logical unit number (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), quad-level cells (QLCs), and penta-level cells (PLCs). For example, an SLC can store one bit of information and has two logic states while a QLC can store sixteen bits of information and has four logic states.

In conventional memory systems, memory devices use different power modes for different activities. For example, memory devices use higher power modes when performing memory operations than when idle (e.g., not performing memory operations). Memory devices in lower power modes consume less power at the cost of taking longer to perform memory operations when the memory subsystem receives memory commands as compared to memory devices in higher power modes. For example, a memory device that is powered off when the memory subsystem receives a memory command will take longer to reach a state in which it is ready to complete the memory command than a memory device that is in a standby mode when the memory subsystem receives the command. Conventional memory systems select power modes based on the components of the memory system to try to optimize power consumption, boot time, and other related variables. For example, memory systems with slower boot up times will use standby mode more frequently than memory systems with faster boot up times. Similarly, memory systems that are more sensitive to power consumption (e.g., memory systems for battery operated devices) will power off more frequently than memory systems that are not as sensitive to power consumption (e.g., a desktop computer). Actual use of these memory systems, however, does not always align with idealized or expected uses. This results in inefficiencies in power consumption, boot time, and other related variables.

Aspects of the present disclosure address the above and other deficiencies by selecting the power mode based on memory usage patterns for the memory subsystem. For example, the memory subsystem tracks the times of received memory commands to determine the memory usage pattern for the memory devices. The memory subsystem uses the memory usage pattern to select an optimal power mode for the current time based on the expected activity of the memory device. For example, the memory subsystem shuts off memory devices during times associated with non-use, thereby reducing power consumption. Similarly, the memory subsystem puts memory devices in a standby mode during times associated with higher use, thereby reducing time for the system to be ready (e.g., boot up time) and saving the power consumption associated with powering the memory devices on. The memory subsystem therefore optimizes the power consumption, boot up time, and other variables by using a power mode that depends on the tracked memory usage patterns for the memory devices.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processing device such as a processor chipset and a software stack executed by the processor chipset. The processor chipset can include one or more cores, one or more caches, a memory controller (e.g., NVDIMM controller), and/or a storage protocol controller (e.g., a peripheral component interconnect express (PCIe) controller, a serial advanced technology attachment (SATA) controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a SATA interface, including a mini-SATA (mSATA) interface, a PCIe interface, including a mini PCIe (mPCIE) interface, a Non-Volatile Memory Express (NVMe) interface, a universal serial bus (USB) interface, an a Fibre Channel, Serial Attached SCSI (SAS), a Small Computer System Interface (SCSI), a double data rate (DDR) memory bus, a dual in-line memory module (DIMM) interface (e.g., DIMM socket interface that supports Double Data Rate (DDR)), an Advanced Host Controller (AHCI) interface, an Open NAND Flash Interface (ONFI) interface, a Double Data Rate (DDR) interface, a Low Power Double Data Rate (LPDDR) interface, any other interface, and/or combinations of these interfaces. The physical host interface can be used to transmit data between the host system 120 and the memory subsystem 110. The host system 120 can further utilize an NVMe interface to access components (e.g., memory devices 130 and 140) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via the same communication connection, multiple separate communication connections, and/or a combination of communication connections.

The memory devices 130 and 140 can include any combination of the different types of non-volatile memory devices and/or volatile memory devices. The volatile memory devices (e.g., memory device 140) can be, but are not limited to, random-access memory (RAM), such as dynamic random-access memory (DRAM), synchronous dynamic random-access memory (SDRAM), video random-access memory (VRAM), and cache memory.

Some examples of non-volatile memory devices (e.g., memory device 130) include negative-and (NAND) type flash memory devices and write-in-place type memory devices, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random-access memory (FeRAM), magneto random-access memory (MRAM), Spin Transfer Torque (STT)-MRAM, nano-RAM (NRAM), silicon-oxide-nitride-oxide-silicon (SONOS) memory, conductive bridging RAM (CBRAM), resistive random-access memory (RRAM), oxide based RRAM (OxRAM), negative-or (NOR) flash memory, and erasable programmable read-only memory (EPROM), including electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The buffer memory of subsystem controller 115 can include any of the volatile or non-volatile memory types mentioned above including combinations thereof. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in memory subsystem 110 (e.g., stored in a local memory 119). In some examples, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processing device or controller separate from the memory subsystem 110).

In general, the memory subsystem controller 115 can receive commands or operations from the host system 120 and can convert the commands or operations into instructions or appropriate commands to achieve the desired access to the memory devices (e.g., memory devices 130 and/or 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA) and/or namespace) and a physical address (e.g., physical block address) that are associated with the memory devices (e.g., memory devices 130 and/or 140). The memory subsystem controller 115 can further include host interface circuitry to communicate with the host system 120 via the physical host interface. The host interface circuitry can convert the commands received from the host system into command instructions to access the memory devices (e.g., memory devices 130 and/or 140) as well as convert responses associated with the memory devices into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices (e.g., memory devices 130 and/or 140).

In some embodiments, the memory devices (e.g., memory devices 130 and/or 140) include local media controllers 135 that operate in conjunction with memory subsystem controller 115 to execute operations on one or more memory cells of the memory devices (e.g., memory devices 130 and/or 140). An external controller (e.g., memory subsystem controller 115) can externally manage the memory devices (e.g., perform media management operations on the memory devices 130 and/or 140). In some embodiments, a memory device (e.g., memory device 130) is a managed memory device, which is a raw memory device combined with a local controller (e.g., local controller 135) for media management within the same memory device package. An example of a managed memory device is a managed NAND (MNAND) device.

The memory subsystem 110 includes an adaptive power cycling component 113 that selects a power mode for memory subsystem 110 using memory usage patterns. In some embodiments, the controller 115 includes at least a portion of the adaptive power cycling component 113. For example, the controller 115 can include a processing device 117 configured to execute instructions stored in local memory 119 for performing the operations described herein. In some embodiments, an adaptive power cycling component 113 is part of the host system 120, an application, or an operating system.

The adaptive power cycling component 113 monitors memory usage patterns and selects a power mode for a memory subsystem using the memory usage patterns. Further details with regards to the operations of the adaptive power cycling component 113 are described below.

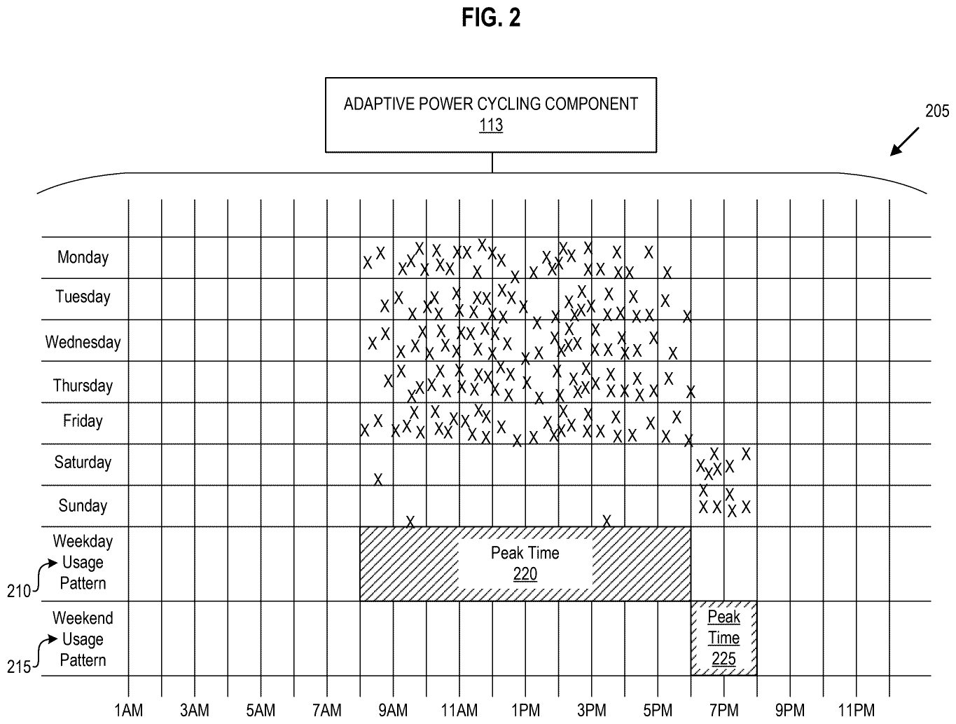

FIG. 2 illustrates a graph of example memory usage patterns for a memory subsystem in accordance with some embodiments of the present disclosure. Adaptive power cycling component 113 tracks received memory commands to determine a usage pattern, as shown in memory usage pattern graph 205, such as weekday usage pattern 210 and/or weekend usage pattern 215. For example, a host system (e.g., host system 120 of FIG. 1) sends memory commands to a memory subsystem (e.g., memory subsystem 110 of FIG. 1). Examples of memory commands can include read, write, and erase memory commands. The memory subsystem stores the received memory commands in a command queue of the memory subsystem while processing each command and adaptive power cycling component 113 tracks the timestamps of memory commands in the command queue. For example, the memory subsystem temporarily stores the received commands including timestamps in a local memory (e.g., local memory 119 of FIG. 1) and adaptive power cycling component 113 reads the timestamps of the received command from the local memory to generate and store a memory usage pattern.

In some embodiments, adaptive power cycling component 113 updates a stored count for the received memory commands based on the timestamp of the received memory commands. For example, adaptive power cycling component 113 maintains a count for the number of memory commands received in each one-hour block per day, such as between 8 am and 9 am on Mondays, in a local memory (e.g., local memory 119). In response to memory subsystem 110 receiving a memory command at 8:35 am on a Monday, adaptive power cycling component 113 updates the stored count by adding one. In such embodiments, adaptive power cycling component 113 can track counts for different subdivisions of times. For example, adaptive power cycling component 113 can track counts for fifteen-minute intervals, thirty-minute intervals, hour intervals, etc. Additionally, in such embodiments, adaptive power cycling component 113 can track counts for different days of the week.

FIG. 2 illustrates memory usage pattern graph 205 showing an X mark for timestamps of memory commands tracked by adaptive power cycling component 113. As shown in the embodiment illustrated in FIG. 2, all the tracked memory commands received during the week (e.g., from Monday to Friday) are received between the hours of 8 am and 6 μm. In such an embodiment, adaptive power cycling component 113 therefore determines weekday usage pattern 210 using the timestamps of received memory commands (e.g., X marks on memory usage pattern graph 205). For example, adaptive power cycling component 113 determines weekday usage pattern 210 with a peak time 220 of the hours of 8 am until 6 pm because the timestamps of all received commands are within peak time 220. In some embodiments, adaptive power cycling component 113 determines weekday usage pattern 210 with a peak time 220 in response to determining that the count of memory commands during the week between the hours of 8 am and 6 pm satisfies a threshold. For example, a peak time threshold can be a number of commands received in a given interval and adaptive power cycling component 113 can use the threshold to identify one or more intervals in a given day that have operation activity levels that reach or exceed that threshold.

In some embodiments, adaptive power cycling component 113 determines different memory usage patterns for different days. For example, as shown in FIG. 2, most of the tracked memory commands received during the weekend (e.g., Saturday and Sunday) are received between the hours of 6 pm and 8 pm. In such an embodiment, adaptive power cycling component 113 determines weekend usage pattern 215 with a peak time 225 of the hours of 6 pm until 8 pm because the majority of all received commands are within peak time 225. In some embodiments adaptive power cycling component 113 determines a peak time based on the number of commands received during a time period satisfying a threshold. For example, adaptive power cycling component 113 determines weekend usage pattern 215 with peak time 225 based on receiving more than ten memory commands in a two-hour period.

In some embodiments, adaptive power cycling component 113 updates the memory usage pattern. For example, memory subsystem 110 receives new memory commands from host system 120 and adaptive power cycling component 113 updates the stored counts based on the timestamps of the new memory commands and updates the memory usage pattern based on updated counts. In some embodiments, adaptive power cycling component 113 clears the counts for received memory commands after a threshold amount of time. For example, adaptive power cycling component 113 clears counts after a week so that the memory usage pattern reflects current memory usage.

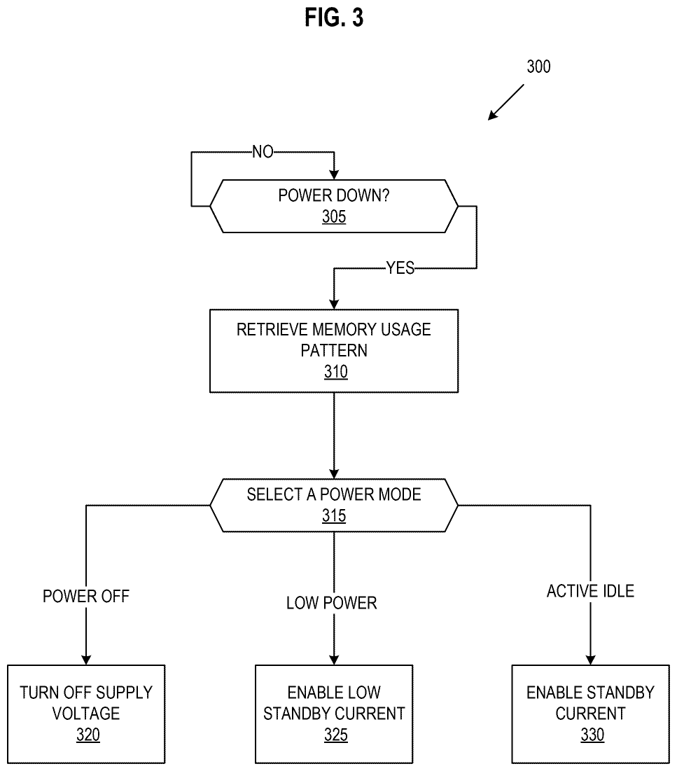

FIG. 3 is a flow diagram of an example method 300 to select a power mode using memory usage patterns, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the adaptive power cycling component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing device determines whether to power down. For example, adaptive power cycling component 113 monitors the voltage supply from host system 120 and determines that memory subsystem 110 is powering down in response to determining that the voltage supply satisfies a threshold value. In some embodiments, adaptive power cycling component 113 determines that a specific memory device is powering down. For example, adaptive power cycling component 113 determines that memory device 140 is powering down by monitoring the voltage supply to memory device 140. In some embodiments, the processing device determines to power down based on the memory usage pattern. For example, adaptive power cycling component 113 determines that peak time 220 has ended and there will likely not be any more memory commands. In some embodiments, rather than determining to power down, the processing device determines to power up. For example, adaptive power cycling component 113 determines to power up based on the memory usage pattern indicating that peak time 220 is beginning. In some embodiments, adaptive power cycling component 113 determines that it is powering down in response to receiving a power down notification from host system 120. If the processing device determines that it is powering down, the method 300 proceeds to operation 310. If the processing device determines that it is not powering down, the method 300 returns to operation 305 to await a trigger to power down or otherwise change power modes.

At operation 310, the processing device retrieves a memory usage pattern. For example, adaptive power cycling component 113 retrieves a memory usage pattern from local memory 119. In some embodiments, the processing device retrieves a memory usage pattern based on a current time and/or day. For example, adaptive power cycling component 113 retrieves weekday usage pattern 210 if a current time is a weekday but retrieves weekend usage pattern 215 if a current time is a weekend. In some embodiments, the processing device determines the memory usage pattern. For example, adaptive power cycling component 113 determines the memory usage pattern as described above with reference to FIG. 2.

At operation 315, the processing device selects a power mode using the memory usage pattern. For example, adaptive power cycling component 113 selects a power mode based on a current time and the retrieved memory usage pattern. In some embodiments, the selected power mode is one of a power off mode, a low power mode, and an active idle mode. For example, adaptive power cycling component 113 selects a power mode by comparing the stored count of the number of received memory commands in the memory usage pattern to thresholds for different power modes. For example, if the count is less than one command, adaptive power cycling component 113 selects a power off power mode, if the count is between one and seven memory commands, adaptive power cycling component 113 selects a low power mode, and if the count is greater than seven, adaptive power cycling component 113 selects an active idle power mode.

In some embodiments, adaptive power cycling component 113 uses different thresholds depending on the day or the week. For example, adaptive power cycling component 113 uses different thresholds for lower power mode and active idle mode during the week than on weekends. In some embodiments, adaptive power cycling component 113 uses different thresholds for lower power mode and active idle mode based on the time of the day. For example, adaptive power cycling component 113 uses one set of thresholds between the hours of 7 am and 12 pm and another set of thresholds between the hours of 12 pm and 8 pm.

In some embodiments, during the most active peak times, adaptive power cycling component 113 selects a power mode of active idle such that memory subsystem 110 is active and awaiting memory commands from host system 120. Continuing the example from above, adaptive power cycling component 113 selects a power mode of active idle if the stored memory command count is greater than seven. Active idle is a power mode with a higher power consumption than power off mode and low power mode but allows memory subsystem 110 to begin processing received memory commands with a shorter boot time than both power off mode and low power mode. Adaptive power cycling component 113 therefore selects active idle mode for times when adaptive power cycling component 113 expects high usage. For example, in the embodiment shown in FIG. 2, adaptive power cycling component 113 selects active idle mode during peak time 220 and peak time 225.

In some embodiments, during intermediate peak times, adaptive power cycling component 113 selects a power mode of low power such that memory subsystem 110 is operating at a standby current (ISB) that is lower than the standby current provided during active idle mode but higher than the current provided during power off mode. Once again continuing the example above, adaptive power cycling component 113 selects a power mode of lower power if the stored memory command count is less than seven but greater than zero. Low power mode, therefore, is a power mode with power consumption greater than power off mode and less than active idle mode but with a boot time less than power off mode and greater than active idle mode. Adaptive power cycling component 113 therefore selects low power mode for times when adaptive power cycling component 113 expects the possibility of usage but not high usage. For example, in the embodiment shown in FIG. 2, adaptive power cycling component 113 selects low power mode on weekends between 8 am and 10 am and between 3 μm and 4 pm since the count of received memory commands during those times is greater than zero but less than seven.

In some embodiments, when not during a peak time, adaptive power cycling component 113 selects a power mode of power off such that memory subsystem turns off supply voltage (V_{CC}). For example, adaptive power cycling component 113 selects a power mode of power off if the stored memory command count is zero. Power off mode, therefore, is a power mode with less power consumption than both low power mode and active idle mode but with a slower boot time than both low power mode and active idle mode. Adaptive power cycling component 113 therefore selects low power mode during times when no activity is expected. For example, in the embodiment shown in FIG. 2, adaptive power cycling component 113 selects power off mode between the hours of 8 μm and 8 am.

Although only illustrated with three power mode options, method 300 can make use of various different power mode options with different expected power consumptions, boot up times, and similar variables. In such embodiments, adaptive power cycling component 113 selects a power mode based on the expected use of memory subsystem 110 using the memory usage pattern.

In some embodiments, the processing device selects the power mode based on a physical memory device. For example, some memory devices have higher power consumption than other memory devices when in a low power or active idle power mode. In such embodiments, adaptive power cycling component 113 therefore selects the appropriate power mode based on the memory devices (e.g., the power consumption characteristics of the memory devices). For example, in the embodiment shown in FIG. 2, adaptive power cycling component 113 selects a power off power mode for an SSD memory device during the weekends between 8 am and 10 am but selects a low power mode for a MNAND memory device during the same time period since the power leakage during low power mode for an SSD memory device is considerably higher than for a MNAND device. In some embodiments, an identifier or other indication of power consumption for the physical memory device is predetermined and stored in a local memory (e.g., local memory 119 of FIG. 1). In such embodiments, adaptive power cycling component 113 can retrieve the identifier from the local memory when selecting the power mode.

If the processing device selects a power off power mode, the method 300 proceeds to operation 320. If the processing device selects a low power mode, the method 300 proceeds to operation 325. If the processing device selects an active idle power mode, the method 300 proceeds to operation 330.

At operation 320, the processing device turns off the supply voltage. For example, adaptive power cycling component 113 causes memory subsystem 110 to turn off the supply voltage. In some embodiments, adaptive power cycling component 113 causes memory subsystem 110 to turn off the supply voltage to a memory device. For example, adaptive power cycling component 113 causes memory subsystem 110 to turn off the supply voltage to memory device 140. In some embodiments, adaptive power cycling component 113 causes memory subsystem 110 to turn off the supply voltage to both an application-specific integrated circuit (ASIC) and a NAND memory device. In some embodiments, memory subsystem 110 turns off the supply voltage (V_{CC}) and the signal supply voltage (V_{CC}Q).

At operation 325, the processing device enables low standby current. For example, adaptive power cycling component 113 causes memory subsystem 110 to operate using a low standby current. In some embodiments, adaptive power cycling component 113 causes memory subsystem 110 to turn off the supply voltage to a NAND memory device but keeps the supply voltage to an ASIC on. In some embodiments, memory subsystem 110 turns off the supply voltage (V_{CC}) but continues to provide signal supply voltage (V_{CC}Q), providing a low standby current to the memory device. In such embodiments where memory device 140 is an MNAND device, memory subsystem 110 turns off the supply voltage (V_{CC}) but continues to provide signal supply voltage (V_{CC}Q) so that memory device 140 is ready for exiting low power mode. In other embodiments, such as where memory device 140 is an SSD device, memory subsystem 110 turns off both the supply voltage (V_{CC}) and the signal supply voltage (V_{CC}Q). In some embodiments, memory subsystem 110 provides a lower supply voltage to memory device 140. For example, a power management circuit of memory subsystem 110 provides a supply voltage (V_{CC}) that is less than the supply voltage (V_{CC}) provided during active idle mode.

At operation 330, the processing device enables standby current. For example, adaptive power cycling component 113 causes memory subsystem 110 to operate using a standby current until memory subsystem 110 receives memory commands. In some embodiments, memory subsystem 110 provides both supply voltage (V_{CC}) and signal supply voltage (V_{CC}Q) during active idle mode. Adaptive power cycling component 113 causes memory subsystem 110 to provide a standby current that is higher than the low standby current provided in low power mode.

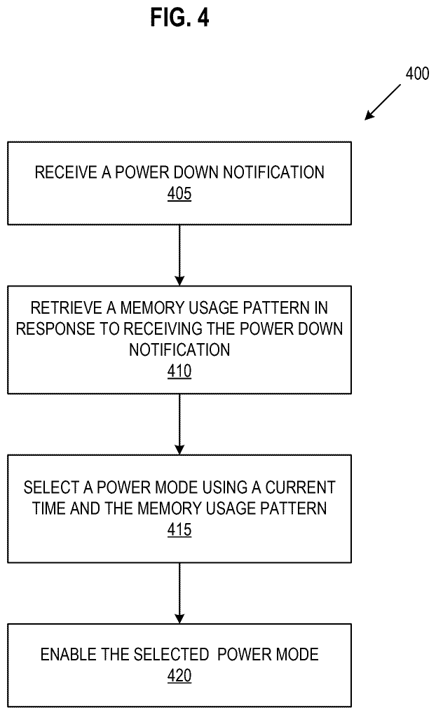

FIG. 4 is another flow diagram of an example method 400 to select a power mode using memory usage patterns, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the adaptive power cycling component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device receives a power down notification. For example, memory subsystem 110 receives a power down notification from host system 120. In some embodiments, adaptive power cycling component 113 determines that memory subsystem 110 is powering down by monitoring the voltage supply from host system 120 and determines that memory subsystem 110 is powering down in response to detecting that the voltage supply satisfies a threshold value. In some embodiments, adaptive power cycling component 113 determines that a specific memory device is powering down. For example, adaptive power cycling component 113 determines that memory device 140 is powering down by monitoring the voltage supply to memory device 140. Further details with regard to receiving a power down notification are discussed with reference to FIG. 3.

At operation 410, the processing device retrieves a memory usage pattern in response to receiving the power down notification. For example, adaptive power cycling component 113 retrieves a memory usage pattern stored in local memory 119 in response to receiving the power down notification. In some embodiments, adaptive power cycling component 113 determines the memory usage pattern by maintaining stored counts of received memory commands per interval based on the timestamps for those memory commands. For example, adaptive power cycling component 113 determines the memory usage patterns as described above with reference to FIGS. 2 and 3.

At operation 415, the processing device selects a power mode using a current time and the memory usage pattern. For example, adaptive power cycling component 113 retrieves a count from the memory usage pattern for the current time interval and the current day. Adaptive power cycling component 113 then selects a power mode in response to the count satisfying or failing to satisfy a threshold count. Returning to the example from above, adaptive power cycling component 113 selects a power mode of power down if the count is less than one, a power mode of low power if the count is between one and seven, and a power mode of active idle if the count is greater than seven.

At operation 420, the processing device enables the selected power mode. For example, adaptive power cycling component 113 sets the supply voltage, signal supply voltage, and/or standby current based on the selected power mode. Further details with regard to enabling the selected power mode are discussed with reference to FIG. 3.

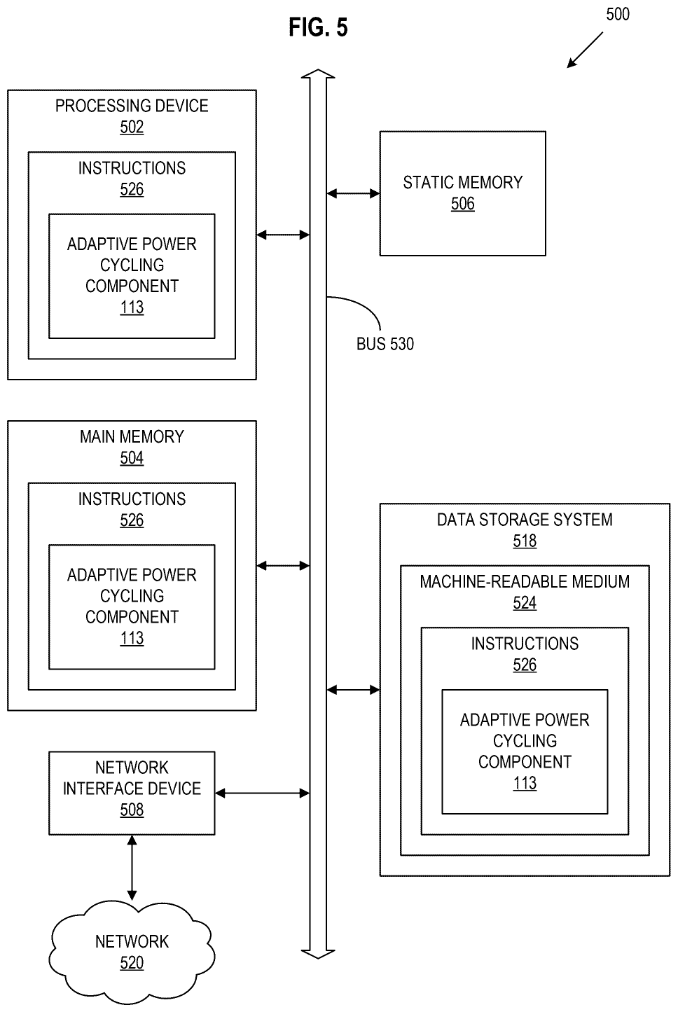

FIG. 5 illustrates an example machine of a computer system 500 within which a set of instructions for causing the machine to perform any one or more of the methodologies discussed herein can be executed. In some embodiments, the computer system 500 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the adaptive power cycling component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a smart device, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random-access memory (DRAM) such as synchronous DRAM (SDRAM) or Rambus DRAM (RDRAM), etc.), a static memory 506 (e.g., flash memory, static random-access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526, constituting machine-readable storage media, can also reside, completely or at least partially, within the main memory 504 and/or within the processing device 502 during execution thereof by the computer system 500, the main memory 504 and the processing device 502. The machine-readable storage medium 524, data storage system 518, and/or main memory 504 can correspond to the memory subsystem 10 of FIG. 1.

In one embodiment, the instructions 526 include instructions to implement functionality corresponding to an adaptive power cycling component (e.g., adaptive power cycling component 113 of FIG. 1). While the machine-readable storage medium 524 is shown in an example embodiment to be a single medium, the term “machine-readable storage medium” should be taken to include a single medium or multiple media that store the one or more sets of instructions (e.g., instructions 526). The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented methods 300 and 400 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random-access memories (RAMs), EPROMS, EEPROMs, magnetic or optical cards, or any type of media suitable for storing electronic instructions coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, by a memory subsystem, a power down notification;
retrieving, in response to receiving the power down notification, a memory usage pattern for the memory subsystem;
selecting a power mode of a plurality of power modes using a current time and the memory usage pattern; and
enabling the selected power mode.

2. The method of claim 1, further comprising:
determining the memory usage pattern using timestamps for a plurality of commands received by the memory subsystem.

3. The method of claim 2, further comprising:
receiving, by the memory subsystem, a new command; and
updating the memory usage pattern based on the new command in response to receiving the new command.

4. The method of claim 1, wherein the memory usage pattern includes a plurality of memory usage patterns for different days and wherein selecting the power mode is further based on a current day.

5. The method of claim 1, wherein the plurality of power modes include power modes for different operating currents and wherein enabling the selected power mode comprises causing the memory subsystem to operate using an operating current associated with the selected power mode.

6. The method of claim 1, wherein selecting the power mode comprises:
determining that the memory subsystem is in a peak time based on the memory usage pattern and the current time, wherein enabling the selected power mode comprises putting the memory subsystem into standby in response to determining that the memory subsystem is in the peak time.

7. The method of claim 1, wherein selecting the power mode comprises:
determining that the memory subsystem is not in a peak time based on the memory usage pattern and the current time, wherein enabling the selected power mode comprises shutting the memory subsystem down in response to determining that the memory subsystem is not in the peak time.

8. A non-transitory computer-readable storage medium comprising instructions that, when executed by a processing device, cause the processing device to:
receive, by a memory subsystem, a power down notification;
retrieve, in response to receiving the power down notification, a memory usage pattern for the memory subsystem;
select a power mode of a plurality of power modes using a current time and the memory usage pattern; and
enable the selected power mode.

9. The non-transitory computer-readable storage medium of claim 8, wherein the processing device is further to:
determine the memory usage pattern using timestamps for a plurality of commands received by the memory subsystem.

10. The non-transitory computer-readable storage medium of claim 9, wherein the processing device is further to:
receive, by the memory subsystem, a new command; and
update the memory usage pattern based on the new command in response to receiving the new command.

11. The non-transitory computer-readable storage medium of claim 8, wherein the memory usage pattern includes a plurality of memory usage patterns for different days and wherein selecting the power mode is further based on a current day.

12. The non-transitory computer-readable storage medium of claim 8, wherein the plurality of power modes include power modes for different operating currents and wherein enabling the selected power mode comprises causing the memory subsystem to operate using an operating current associated with the selected power mode.

13. The non-transitory computer-readable storage medium of claim 8, wherein selecting the power mode comprises:
determining that the memory subsystem is in a peak time based on the memory usage pattern and the current time, wherein enabling the selected power mode comprises putting the memory subsystem into standby in response to determining that the memory subsystem is in the peak time.

14. The non-transitory computer-readable storage medium of claim 8, wherein selecting the power mode comprises:
determining that the memory subsystem is not in a peak time based on the memory usage pattern and the current time, wherein enabling the selected power mode comprises shutting the memory subsystem down in response to determining that the memory subsystem is not in the peak time.

15. A system comprising:
a plurality of memory devices; and
a processing device, operatively coupled with the plurality of memory devices, to:
determine a memory usage pattern for a memory subsystem using timestamps for a plurality of commands received by the memory subsystem;
receive, by a memory subsystem, a power down notification;
retrieve, in response to receiving the power down notification, a memory usage pattern for the memory subsystem;
select a power mode of a plurality of power modes using a current time and the memory usage pattern; and
enable the selected power mode.

16. The system of claim 15, wherein the processing device is further to:
receive, by the memory subsystem, a new command; and
update the memory usage pattern based on the new command in response to receiving the new command.

17. The system of claim 15, wherein the memory usage pattern includes a plurality of memory usage patterns for different days and wherein selecting the power mode is further based on a current day.

18. The system of claim 15, wherein the plurality of power modes include power modes for different operating currents and wherein enabling the selected power mode comprises causing the memory subsystem to operate using an operating current associated with the selected power mode.

19. The system of claim 15, wherein selecting the power mode comprises:
determining that the memory subsystem is in a peak time based on the memory usage pattern and the current time, wherein enabling the selected power mode comprises putting the memory subsystem into standby in response to determining that the memory subsystem is in the peak time.

20. The system of claim 15, wherein selecting the power mode comprises:
determining that the memory subsystem is not in a peak time based on the memory usage pattern and the current time, wherein enabling the selected power mode comprises shutting the memory subsystem down in response to determining that the memory subsystem is not in the peak time.
